(19) United States
(12) Patent Application Publication
(10) Pub. No.: US 2009/0314702 A1
(43) Pub. Date: Dec. 24, 2009

(54) Rapid transfer and mixing of treatment fluid into a large confined flow of water

(76) Inventor: Angelo L. Mazzei, Bakersfield, CA (US)

Correspondence Address: James M. Duncan, Klein, DeNatale, Goldner,;Rosenlieb & Kimball, LLP, P.O. Box 11172, Bakersfield, CA, 93389-1172, US

(21) Appl. No.: 12/214,536

(22) Filed: Jun. 19, 2008

(51) Int. Cl. C02F 1/00; C02F 1/20; C02F 103/06

(52) U.S. Cl. 210/199

(57) ABSTRACT

A system for rapid transfer and mixing of treatment substance into a larger confined flow of water. By-pass flow from the main flow receives treatment substance and returns to the main flow through a pair of directly opposed nozzles are directed across the main flow.

### FIELD OF THE INVENTION

The rapid transfer and uniform mixing of treatment fluid, ozone, for example, into a major flow of water through a large conduit, for example in the treatment of water in municipal installations

### BACKGROUND OF THE INVENTION

Treatment of water in municipal and industrial sites generally starts with raw water from some source from which solids are extracted, and subsequent treatment with injected treatment substances. The objective is commonplace- the effluent water is to be clarified and purified sufficiently to be acceptable into the water distribution system.

This is an age-old objective, generally involving filtration separation, and chemical treatment to eliminate objectionable organisms. As cities and systems have grown in size, so has their need to treat water that requires more treatment and more real estate for the treatment facilities to occupy.

Large settling ponds that could formerly be accepted are increasingly unsuitable for growing systems. The dwell-time and consequences of known treatments were and are too costly in processing, in equipment, and in space to put the equipment. Often a less desirable system was selected despite its disadvantages because it was the best available.

Large flows of water in confinement as contemplated by this invention are large diameter pipes, usually 8 inches inside diameter or larger flowing full under pumped pressure. Larger diameters are contemplated, and smaller ones also fall within the scope of this invention. However, the systems of greatest interest are those with flow rates between about 2 and 200 million gallons per day.

These are rapid flows into which this invention injects treatment gas in the pipe without interruption of the major flow. With this invention settling ponds, dwell tanks and the like become unnecessary or the need for them is greatly reduced. It is an object of this invention to provide injection of treatment substances in-such a way that they will be throughly mixed with the flowing stream while in the pipe, without impeding the major flow. Treatment substances will generally be fluid, this term includes liquids and gases.

Prior art projects, such as shown in United States patent to Mazzei, U.S. Pat. No. 6,730,214 have suggested injection of treatment gas into the stream, but generally this was done in the main stream, and the total system was divided in two parts that were later combined. The loss of energy is apparent, as is the increase in required equipment and real estate on which to place it (see its FIG. 1).

The ultimate mixing of the treatment gas into the mainstream depends in large part on the means by which it is injected into the main stream. Optimizing and accelerating this mixing is the principal objective of this invention, and is sometimes called flash mixing. However, ultimate mixing is further improved by providing treatment gas already well-distributed in its own supply stream, and delivered in an optimum stream to the major flow. This invention fosters this additional object.

### BRIEF DESCRIPTION OF THE INVENTION

This invention is used in a confined-flow conduit under pressure such as a pipe. The system has an upstream end and an effluent end. Between these ends there is an unimpeded region of flow. A by-pass conduit extends into this region from upstream of it.

The purpose of this by-pass conduit is to by-pass a portion of the total stream while receiving one or more from mixer-injectors correct amounts of treatment gas, and then branching into at least one pair of injection nozzles that discharge the additive-laden fluid into the said region. Treatment gas is given here as an example of a treatment substance, either gas or liquids.

According to this invention the member of the pairs of nozzles are directed into the main stream in the same plane, preferably a plane that includes the central axis.

According to a preferred but optional feature of the invention a plurality of these pairs, spaced apart longitudinally from each other are provided.

According to other optional features of this invention, advantage can be taken of improvements to mixer-injectors, and injection nozzles described in the following United States patents to Mazzei, U.S. Pat. Nos. 5,863,129 and 5,894,995. With the use of some or all of these products, the performances of the major system are further improved.

This system operates with no impediment to free flow through it, and with only a moderate loss of energy consumed in the operation of the by-pass conduit. This is an effective small-footprint system which requires little or no separate power and little operational attention.

The above and other features of this invention will be fully understood from the following detailed description and the accompanying drawings, in which:

### BRIEF DESCRIPTION OF THE DRAWINGS

FIG. 1 is a semi-schematic drawing of the preferred embodiment of system according to this invention;

FIG. 2 is a cross-section taken at line 2-2 in FIG. 1;

FIG. 3 is an axial cross-section of the presently preferred mixer injector for use in gas systems; and

FIG. 4 is an axial cross-section of the presently preferred nozzle for use in this system.

### DETAILED DESCRIPTION OF THE INVENTION

A pipe 10 for carrying a substantial flow of water to be treated has an upstream intake end 11 and an effluent end 12. Between these ends is a mixing region 13. The direction of total flow is shown by arrows 14. These ends and regions are at arbitrary locations with the pipe. For example, the ends are not necessarily ends of pipe segments, nor is region 13 well-defined. These items are given to designate respective generalized locations in the continued unimpeded flow through the pipe.

A by-pass conduit 20 extends through the pipe wall 21 upstream of the region, and divides into two branches 22, 23.

As best shown in FIG. 2, branch 22 flows into the intake 24 of a mixer-injector 25, and from its outlet 27 divides into branches 30, 31. Branches 30, 31 discharge into respective nozzles 34, 35. Branch 23 includes identical elements, branches 30a and 31a, mixer-injector 25a, and nozzles 34a and 35a.

Nozzles 34 and 35 have respective discharge axes 37, 38. Importantly, in the preferred construction these axis are co-axial and confrontational, directly across a major part of the cross-section of the pipe. When the pipe is circular they will 23 intersect the center 39 of the lumen of the pipe. Similar relationships exist with nozzles 34 and 35 and their respective axes.

Coaxial discharge of the nozzles of this pair is preferred but optional. However, they should be in the same plane, but may make an angle with each other as the center of the pipe.

Treatment gas or other additives is supplied to the mixer injectors from a supply 40 which discharges to the respective mixer-injectors through pipes 41, 42. The additive used in this invention for large-scale operations will usually be ozone, but instead may be other treatment gases such as chlorine or oxygen or aqueous solutions of various types. The identity of the treatment substance is not a limitation in this invention. The term treatment substance is used for all fluid additives, the word fluid including both gases and liquids.

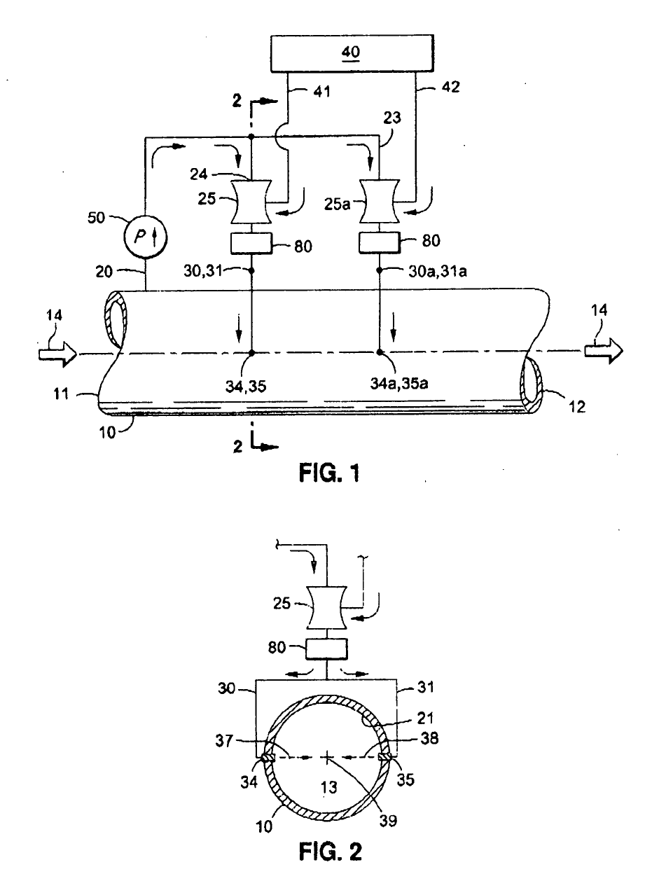

Two pairs of these nozzles, as shown in FIGS. 1 and 2 are preferable, although only one and as many as four pairs may be used. When more than one pair is provided, nozzles will preferably be axially aligned along the pipe as shown.

It does require some power to remove the by-pass flow, pass it through the mixer-injector and return it to the main flow. An auxiliary pump 50 is provided for this purpose. Instead other known means to provide a differential passing may be utilized.

The ultimate objective of this invention is to inject treatment substances into the flowing confined system so that it is rapidly thoroughly distributed in the total flow, and in a condition that there is little remaining undissolved treatment gas to lose to the atmosphere.

Dwell time is of importance for the in actuation of an organism or oxidation of contaminates. Generally, increase of time in conventional installations requires a proportional increase in the size of the installation. Reduction of the reaction time ended by this invention further enables reduction of plant size.

For this purpose the principal advantage of this invention is derived from the head-on collision of the opposing streams from opposing members of a pair of nozzles into the main stream. Injectors as simple as the one shown in Mazzei U.S. Pat. No. 4,123,800, will serve. However, this older injection design does not fully address the fine-division of bubbles of treatment gas injected into the by-pass stream for purposes of speeding the reaction.

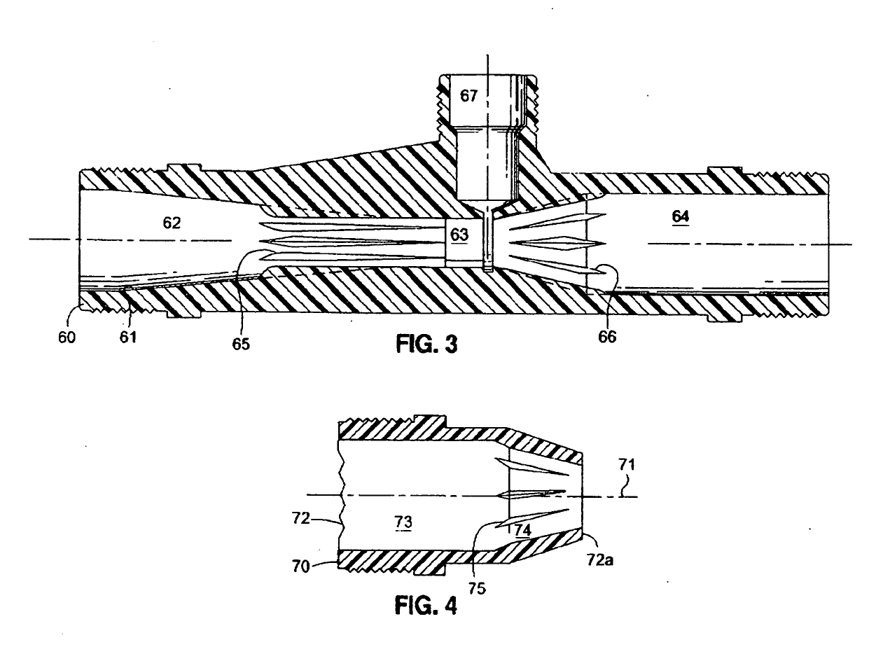

This function is addressed by the mixer-injector fully shown and described in Mazzei U.S. Pat. No. 5.863,128. FIG. 3 will be recognized as FIG. 1 of this patent. It is characterized by a body 60 having a circular passage 61 with a converging section 62, an injection section 63 and a diverging section 64. Twisting vanes 65 are formed on the wall of the converging section, and straightening vanes 66 are formed on the wall of the diverging section. Treatment gas from branch 67 is fed into the injection section. The structure and function of this mixer-injector will be fully understood from that patent, which is incorporated herein by reference in its entirety.

FIG. 4 will be recognized as FIG. 3 of Mazzei U.S. Pat. No. 5,894,995, which patent is referred to herein and incorporated in its entirety for its showing of the preferred nozzle for use in this invention. This nozzle includes a body 70 with a central axis 71, an upstream end 72 and a discharge end 72a. Its internal inside bore 73 is reduced by a converging section 74 into which a plurality of twisting vanes 75 is placed. The result is to discharge a strong stream of water whose outside boundary is twisted relative to the inside *cores of the stream thereby providing a further mixing of the treatment substances.

The nozzles of the two pairs of nozzles in FIG. 1 are axially aligned. Extensive tests have shown this to be preferable to arrangements in which the nozzles are not normal to the axis of the stream. The nozzles should be *pointing: in a plane that incorporates the central. Divergence of the nozzle axis from a plane that is normal to the central axis is acceptable, within limits. It will be recognized that, while the discharged streams will be somewhat deflected by the main flow, depending on the velocity of the main flow, initial discharge normally to the axes of flow provides best results.

In actual operation, main line flows through the reactive section will usually be between about 2 to 10 feet per second, and between about 7 to 25 percent of the total flow of the system will be through the by-pass. The hydrodynamics of these systems is very arbitrary. The system as described and claimed herein has been developed with the objective of the most complete and uniform mixing of treatment substances into the total flow. Experimentation has shown that, especially with use of the mixer-injector of FIG. 3 and the nozzles of FIG. 4, nearly uniform distribution over the entire cross-section of the lumen is attainable, all at low cost. The very fine division of gas bubbles within a few seconds in the mixer-injector of FIG. 3 is an especial improvement to this system all at lower cost.

The principal objective of this invention is to speed into a solution a treatment gas in a uniform manner. A pervious problem, especially when ozone is the treatment gas, is that it is obtained from oxygen or from oxygen in the air. Accordingly, the treatment gas when ozone will include oxygen, which can cause significant erosion and corrosion problems. For this reason, treatment system flow included degassing devices.

Ozone itself readily dissolves, at least in concentrations contemplated by this invention-is different, and will often remain in bubbly form. There is attained to by degassing devices such as shown in U.S. Pat. No. 5,622,545 which is incorporated herein by reference. When used it is best practice to remove the gas before it enters the main stream. Accordingly degassed 80 and 81 are shown downstream to each mixer-injector, which may be any degassing device shown or described in said U.S. Pat. No. 6,730,214.

This invention is not to be limited by the embodiments shown in the drawings and described in the description, which are given by way of example and not of limitation, but only in accordance with the scope of the appended claims.

1. A system to inject treatment substances into a flowing stream of water contained in a closed cylindrical structure having a flow axis, said cylindrical structure comprising an outer wall with an axially-extending lumen with a region where injection occurs, and an upstream end and a downstream end, said system comprising:
a by-pass conduit passing through said outer wall;
an injector having an inlet connected to said by-pass conduit, an outlet, and a treatment substance entry port, said injector having an internal converging section at said inlet, an internal diverging section at said outlet, and between said converging and diverging sections, an injector section also connected to said treatment substance entry port;
a pair of injector nozzles fitted in and discharging into said lumen, said nozzles each having a discharge axis, receiving equal amounts of flow from said injector, said discharge axes generally normal to said flow axis;
a pump impelling water through said by-pass conduit; and
a source of treatment substance connected to said substance entry port; whereby
with water flowing through said cylindrical structure and by-pass water flowing through said by-pass conduit, the by-pass water passes through said injector, receiving treatment substance from said source, flow from said injector divides to the nozzles of said pair, and is injected into the flowing water stream generally normal to the flow axis there to mix into the flowing stream.

2. A system according to claim 1 in which the discharge axes of the members of each pair are substantially co-linear.

3. A system according to claim 1 in which said structure is a pipe, and the flowing stream substantially fills said pipe.

4. A system according to claim 1 in which twisting vanes are provided in the wall of said converging section, and straightening vanes are provided in the wall of said diverging section.

5. A system according to claim 1 in which a plurality of said pairs of nozzles are provided together with an injector for each pair, all of said injectors being connected to said by-pass conduit and to said source.

6. A system according to claim 4 in which a plurality of said pairs of nozzles is provided, the nozzles of all of said pairs being axially aligned along said structure, said pairs being axially spaced from each other.

7. A system according to claim 1 in which a degassing device is provided between each mixer-injector and the nozzles through which it exists.
